(19) United States
(12) Patent Application Publication
(10) Pub. No.: US 2024/0134708 A1
(43) Pub. Date: Apr. 25, 2024

(54) Bin Packing

(71) Applicant: Google LLC, Mountain View, CA (US)

(72) Inventors: Md Ehtesamul Haque, Santa Clara, CA (US); Thomas John Chestna, Middleborough, MA (US); Samuel Justin Smith, Mountain View, CA (US); Pedro Daniel Valenzuela Salvatierra, Santa Clara, CA (US); Olivier Robert Sevin, Winston-Salem, NC (US)

(21) Appl. No.: 17/971,783

(22) Filed: Oct. 23, 2022

(51) Int. Cl. G06F 9/50; G06F 9/455

(52) U.S. Cl. CPC G06F 9/5055; G06F 9/45558; G06F 2009/4557

(57) ABSTRACT

A system and method for assigning a workload to one of a plurality of candidate host machines of a computing environment. The method may include receiving a request to schedule a workload, selecting a virtual machine type for executing the workload, for each candidate host machine of the plurality of candidate host machines, determining an expected waste score indicating a likelihood of resources at the candidate host machine remaining unused if the virtual machine type is assigned to the candidate host machine, selecting the candidate host machine for which the expected waste score is the lowest, and assigning the workload to the selected candidate host machine.

### BACKGROUND

Bin packing algorithms are typically employed to ensure efficient use of resources, such as CPU processing, memory storage, solid-state drive (SSD) storage, and so on. For workload management within a computing environment, two typical objectives of bin packing algorithms are to reduce resource stranding in the computing environment and to maintain large enough spaces to handle large workloads.

One conventional bin packing algorithm, referred to as a “best fit” algorithm, tries to fill host machines of the computing environment as much as possible by selecting virtual machines (VMs) for which the ratio of free resources after binding the VM to the host is lowest for each of the evaluated resources. One drawback of best-fit algorithms is that each dimension is scored in isolation, sometimes leading to overall inefficiencies when a single dimension scores well. For example, if a VM requests 2 CPUs and 1 GB RAM, a first available host has 2 CPUs and 8 GB of free RAM, and a second available host has 4 CPUs and also 8 GB of free RAM, then the best-fit algorithm would select the first available host to bind the VM. This is because selecting the first host perfectly packs CPU usage at the first host, whereas selecting the second host leaves over 2 CPUs at each of the two hosts, which may ultimately result in stranding of the leftover 2 CPUs at each of the hosts. However, while selecting the first host leads to perfect packing in the CPU dimension, it has the opposite effect in the memory dimension, exhausting the available CPUs while stranding 7 GB of remaining RAM at the first host, and thereby leading to an overall inefficiency for the system.

Another known bin packing algorithm that improves on the bin packing algorithm involves considering for each host machine the number of different types of VMs that could be hosted before binding the VM to the host, and the number of different types of VMs that could be hosted after binding the VM to the host, and selecting the host machine for the difference between those two numbers is smallest. Additional tiebreakers are often used for host selection, such as considering which host machine could fit the most VMs in the remaining space after binding the VM, or considering for which host machine the ratio of free RAM to CPU after binding the VM is closest to a target value. While this algorithm improves upon the conventional bin packing algorithm by considering CPU and memory together, there are still inefficiencies in the algorithm. In particular, host selection is predicated on an arbitrary set of VM shapes that may or may not reflect the actual distribution of VMs in the computing environment.

### BRIEF SUMMARY

The present disclosure provides an improved bin packing algorithm that takes into account the distribution of VMs in a computing environment. This is performed by determining, for each candidate host machine, an expected waste added to the host by binding the VM to the host. The host having the least amount of expected waste is then selected as the host. Expected waste is a pre-calculated value that takes into account the known distribution of VMs for a given computing environment, such as a cluster. Since expected waste values can be pre-calculated, these values can be stored in a lookup table in advance, and determining the change in expected waste for each host machine can be accomplished with just a few lookups to the lookup table.

In one aspect of the present disclosure, a method of assigning a workload to host machines of a computing environment may include: receiving, by one or more processors, a request to schedule a workload; selecting, by the one or more processors, a virtual machine type for executing the workload; for each candidate host machine of a plurality of candidate host machines, determining, by the one or more processors, an expected waste score indicating a likelihood of resources at the respective candidate host machine remaining unused if the virtual machine type is assigned to the respective candidate host machine, wherein the expected waste score is based on a predetermined set of available virtual machine types for the computing environment, wherein the selected virtual machine type for executing the workload is included in the set of available virtual machine types for the computing environment; and assigning, by the one or more processors, the workload to the respective candidate host machine having the lowest expected waste score.

In some examples, the request to schedule the workload may indicate an amount of resources consumed by the workload, and selecting the virtual machine type for executing the workload may be based on the amount of resources consumed by the workload.

In some examples, determining the expected waste score may involve accessing, by the one or more processors, predetermined expected waste values, each predetermined expected waste value corresponding to a different set of available resources.

In some examples, determining the expected waste score further involve: determining, by the one or more processors, a current set of available resources at the candidate host machine; determining, by the one or more processors, a first expected waste value corresponding to the current set of available resources from the predetermined expected waste values; determining, by the one or more processors, a resultant set of available resources at the candidate host machine if the virtual machine type is assigned to the candidate host machine; determining, by the one or more processors, a second expected waste value corresponding to the resultant set of available resources from the predetermined expected waste values; and determining, by the one or more processors, a difference between the first expected waste value and the second expected waste value.

In some examples, the resources at the candidate host machine may include each of processing resources and storage resources, and the predetermined expected waste values may be based on both processing resources and storage resources.

In some examples, the processing resources may include a number of central processing units (CPUs), and the storage resources may include at least one of an amount of random access memory or an amount of solid-state drive memory.

In some examples, assigning the workload to the selected candidate host machine may involve: binding, by the one or more processors, a virtual machine of the determined virtual machine type to the selected candidate host machine; and assigning the virtual machine to execute the workload.

In some examples, the method may further include calculating the expected waste values before the request to schedule the workload is received.

In some examples, calculating the expected waste values may involve: selecting, by the one or more processors, a first set of resources; for each virtual machine type of a plurality of virtual machine types, determining, by the one or more processors, a first likelihood of resources being unused if a hypothetical virtual machine of the virtual machine type were added to a hypothetical host machine of the computing environment having the first set of resources; and deriving, by the one or more processors. a first expected waste value from the determined first likelihoods of the plurality of virtual machine types; selecting, by the one or more processors, a second set of resources, wherein the first set of resources is a subset of the second set of resources; for each virtual machine type of a plurality of virtual machine types, determining, by the one or more processors. a second likelihood of resources being unused if a hypothetical virtual machine of the virtual machine type were added to a hypothetical host machine of the computing environment having the second set of resources, wherein at least one second likelihood is determined based at least in part on the first expected waste value; and deriving, by the one or more processors, a second expected waste value from the determined second likelihoods of the plurality of virtual machine types.

In some examples, each of the first likelihoods and each of the second likelihoods may be weighted according to a predetermined distribution of the plurality of virtual machine types in the computing environment.

Another aspect of the disclosure is directed to a system for assigning a workload to a host machine of a computing environment, the system including: one or more processors; and memory storing instructions configured to cause the one or more processors to: receive a request to schedule a workload; select a virtual machine type for executing the workload; for each candidate host machine of a plurality of candidate host machines, determine an expected waste score indicating a likelihood of resources at the candidate host machine remaining unused if the virtual machine type is assigned to the candidate host machine, wherein the expected waste score is based on a predetermined set of available virtual machine types for the computing environment, wherein the selected virtual machine type for executing the workload is included in the set of available virtual machine types for the computing environment; select the candidate host machine for which the expected waste score is lowest; and assign the workload to the selected candidate host machine.

In some examples, the request to schedule the workload may indicate an amount of resources consumed by the workload, and the instructions may be configured to cause the one or more processors to select the virtual machine type for executing the workload based on the amount of resources consumed by the workload.

In some examples, the instructions may be configured to cause the one or more processors to access predetermined expected waste values, each predetermined expected waste value corresponding to a different set of available resources.

In some examples, the instructions may be configured to cause the one or more processors to: determine a current set of available resources at the candidate host machine; determine a first expected waste value corresponding to the current set of available resources from the predetermined expected waste values; determine a resultant set of available resources at the candidate host machine if the virtual machine type is assigned to the candidate host machine; determine a second expected waste value corresponding to the resultant set of available resources from the predetermined expected waste values; and determine a difference between the first expected waste value and the second expected waste value, the expected waste score indicating the difference between the first expected waste value and the second expected waste value.

In some examples, the resources at the candidate host machine may include each of processing resources and storage resources, and the predetermined expected waste values may be based on both processing resources and storage resources.

In some examples, the processing resources may include a number of central processing units (CPUs), and the storage resources may include at least one of an amount of random access memory or an amount of solid-state drive memory.

In some examples, the instructions may be configured to cause the one or more processors to: bind a virtual machine of the determined virtual machine type to the selected candidate host machine; and assign the virtual machine to execute the workload.

In some examples, the instructions may be configured to cause the one or more processors to calculate the predetermined expected waste values before the request to schedule the workload is received.

In some examples, the instructions may be configured to cause the one or more processors to: select a first set of resources; for each virtual machine type of a plurality of virtual machine types, determine a first likelihood of resources being unused if a hypothetical virtual machine of the virtual machine type were added to a hypothetical host machine of the computing environment having the first set of resources; derive a first expected waste value from the determined first likelihoods of the plurality of virtual machine types; select a second set of resources, wherein the first set of resources is a subset of the second set of resources; for each virtual machine type of a plurality of virtual machine types, determine a second likelihood of resources being unused if a hypothetical virtual machine of the virtual machine type were added to a hypothetical host machine of the computing environment having the second set of resources, wherein at least one second likelihood is determined based at least in part on the first expected waste value; and derive a second expected waste value from the determined second likelihoods of the plurality of virtual machine types.

In some examples, each of the first likelihoods and each of the second likelihoods may be weighted according to a predetermined distribution of the plurality of virtual machine types in the computing environment.

### BRIEF DESCRIPTION OF THE DRAWINGS

FIG. 1 is a block diagram of a system in accordance with an aspect of the disclosure.

FIG. 2 is a block diagram of a workload scheduler in accordance with an aspect of the disclosure.

FIG. 3 is a diagram showing changes in storage capacity of a plurality of host machines managed by a workload scheduler in accordance with an aspect of the disclosure.

FIG. 4 is a flow diagram illustrating expected value calculation in accordance with an aspect of the disclosure.

FIG. 5 is an illustration of a table of expected value calculations in accordance with the routine of FIG. 4.

FIG. 6 is a flow diagram of an example routine for workload assignment in accordance with an aspect of the disclosure.

### DETAILED DESCRIPTION

### Overview

The present disclosure leverages a known distribution of VMs in a computing environment to predict the likelihood of resources, such as computing power or memory, being stranded at a host machine in the event that a virtual machine is added to the host machine. This prediction can be used to make informed decisions as to which one of several candidate host machines is best suited for the virtual machine to be added to it.

In order to select the best suited host machine, the system may compare a current likelihood of stranding without adding the VM to a resultant likelihood of stranding if the VM were added. If the likelihood of stranding, which is referred to herein as “expected waste,” goes down, then the host machine may be a good candidate. Conversely, if the expected waste goes up, then the host machine may be a bad candidate. The host machine for which the expected waste drops the most, or rises the least, may be selected as the best suited.

The likelihood of stranding, or expected waste value, may be tied to the set of resources available at the host machine. Each value can be calculated in advance, placed in storage, and then accessed when needed to select candidate host machines for VMs that are to be added to the computing environment. The advanced calculation may involve recursive determinations of likelihood stranding, in which predictions for relatively small sets of resources are calculated first, and then predictions for relatively larger sets of resources are calculated based on the prior predictions. Example calculations are provided herein in connection with the example methods.

In order to make informed predictions of the likelihood of stranding for the different possible sets of resources, the distribution of virtual machine types in the computing environment may be taken into account. In this sense, a computing environment in which many large workloads are received may place a greater priority on leaving open large spaces for large workloads on a few host machines, wherein a computing environment in which small workloads are predominantly received may place a lower priority on leaving open such large spaces.

The systems and techniques of the present disclosure can achieve lower rates of resource stranding across one or more computing environments, leading to better overall efficiency and reduced operating costs. Additionally, the use of precalculated values to determine the likelihood of stranding allows for host machine selection to be performed more quickly than for bin packing algorithms requiring likelihood of stranding prediction at the time of host machine selection.

### Example Systems

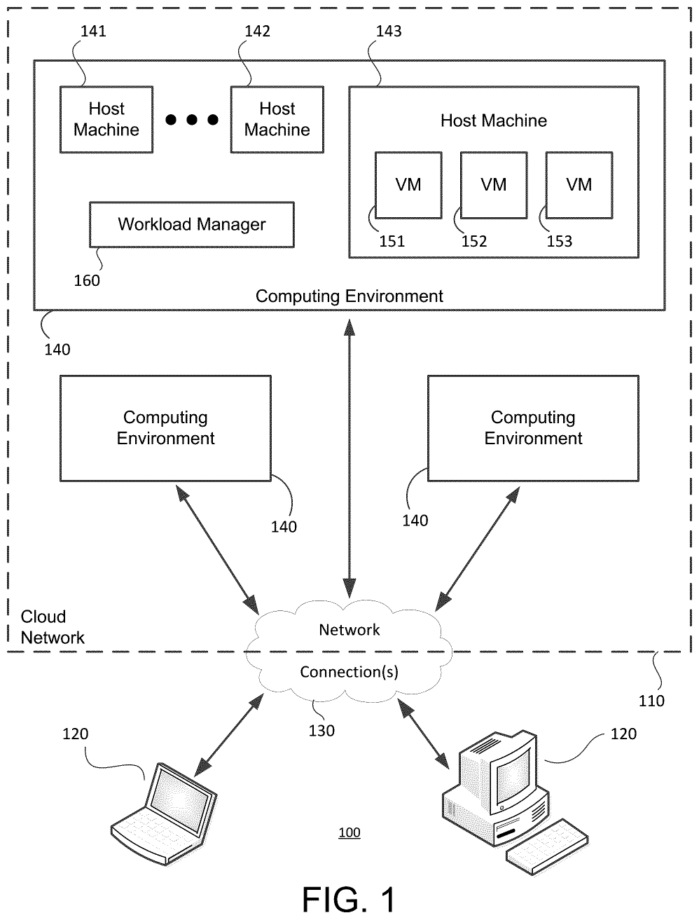

FIG. 1 is a block diagram of an example system 100 for processing workloads. The system 100 includes a cloud-based network 110 of computing devices connected to one or more client devices 120 through one or more network connections 130.

The cloud-based network 110 may be divided into a plurality of separate computing environments 140, such as cloud cells, which may also be referred to as clusters. A cell is a network of tightly connected computing devices that, by way of example, may cooperatively run processes, have shared storage, and has very low network latency and high throughput between computing devices in the cell. Each cloud cell may include its own hardware and software independent of the other cloud cells. In some examples, computing environments may be arranged to share some components with one another while keeping other components separate.

In the example of FIG. 1, each computing environment may include its own computing devices that may act as host machines 141, 142, 143, such as one or more computers or servers for hosting one or more virtual machines (VMs) 151, 152, 153 within the computing environment. Data and instructions provided to the cloud network 110 may be directed to a particular computing environment 140 for processing and storage at the processing resources such as processors, and the storage resources such as memory, of the computing environment 140. The various resources may be designated to VMs 151, 152, 153 at a corresponding host machine 143 of the computing environment 140 as the VMs are created to handle the various instructions and data that are received from the client devices 120 or the other computing environments 140. Instructions and data may include data sets, workloads or jobs to be executed on the data sets, or a combination thereof.

Each client device 120 may be, for example, a computer. The client device 120 may have all the internal components normally found in a personal computer such as a central processing unit (CPU), CD-ROM, hard drive, and a display device, for example, a monitor having a screen, a projector, a touch-screen, a small LCD screen, a television, or another device such as an electrical device that can be operable to display information processed by processor, speakers, a modem and/or network interface device, user input, such as a mouse, keyboard, touch screen or microphone, and all of the components used for connecting these elements to one another. Moreover, computers, as used herein, may include any devices capable of processing instructions and transmitting data to and from humans and other computers, including, by way of example and without limitation, general purpose computers, PDAs, tablets, mobile phones, smartwatches, network computers lacking local storage capability, set top boxes for televisions, other networked devices, etc.

The one or more network connections 130 may include various configurations and protocols including the Internet, World Wide Web, intranets, virtual private networks, wide area networks, local networks, private networks using communication protocols proprietary to one or more companies, Ethernet, WiFi (e.g., 702.71, 702.71b, g, n, or other such standards), and HTTP, and various combinations of the foregoing. Such communication may be facilitated by a device capable of transmitting data to and from other computers, such as modems (e.g., dial-up, cable or fiber optic) and wireless interfaces.

Each computing environment 140 may further include a respective workload scheduler or workload manager 160 for handling the received workloads. Handling workloads may involve choosing a particular type of VM best suited for executing the workload, choosing a particular host machine best suited for hosting the VM, as well as instantiating and binding a VM of the chosen VM type to the chosen host machine. VM types may vary depending on resources committed to the VM, whereby each VM type may be considered to have a different “shape,” referring to the respective amounts of different types of resources committed to the VM. Resource types may include, but are not limited to, a number of central processing units (CPUs), an amount of available random-access memory, an amount of solid-state drive memory, and so on.

The workload manager 160 can handle a stream of workloads received at the computing environment 140. For instance, the computing environment may include a workload queue, and the workload manager 160 may choose VM types and host machines for each of the received workloads according to an order specified by the workload queue.

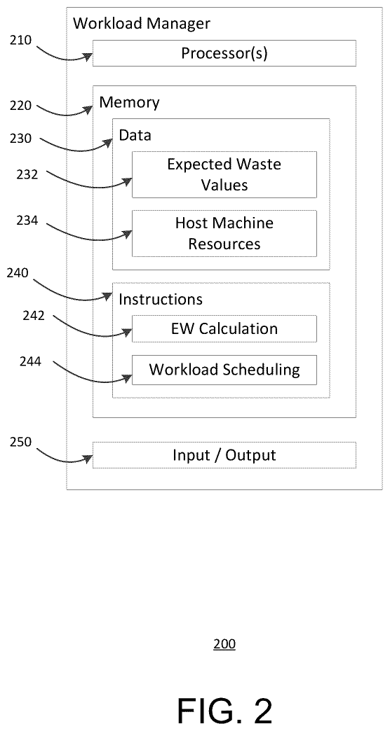

FIG. 2 is a block diagram of a workload manager 200, such as the workload manager 160 of the system 100 of FIG. 1. The workload manager 200 includes one or more processors 210, as well as memory 220.

The one or more processors 210 may include a well-known processor or other lesser-known types of processors.

The memory 220 can store information accessible by the processor 210, including data 230 that can be retrieved, manipulated or stored by the processor, instructions 240, 280 that can be executed by the processor 210, or a combination thereof. The memory 220 may be a type of non-transitory computer-readable medium capable of storing information accessible by the processor 210 such as a hard-drive, solid state drive, tape drive, optical storage, memory card, ROM, RAM, DVD, CD-ROM, write-capable, and read-only memories.

Although FIG. 2 functionally illustrates the processors 210 and memory 220 as being included within a single block, the processors and memory may actually include multiple processors and memories that may or may not be stored within the same physical housing. For example, some of the data and instructions can be stored on a removable CD-ROM, persistent hard disk, solid-state drive (SSD), and others. Some or all of the instructions and data can be stored in a location physically remote from, yet still accessible by, the processor. Similarly, the processor can actually include a collection of processors, which may or may not operate in parallel.

The workload manager 200 may further include input/output components 250 for receiving and transmitting data with other components of the system. Received data and instructions may include streams of workload scheduling requests, and transmitted data may include instructions to the computing environment to assign computing and storage resources to VMs that are scheduled to perform the workloads. In some examples, the input/output components 250 of workload managers 200 may also be capable of communication between computing environments.

The data 230 stored in memory 220 may include information that is needed for the workload management operations executed by the workload manager 200. For example, the data 230 may include expected waste values 232 that may be used to determine the expected waste for a host machine to which a VM is assigned. “Waste” may refer to the amount of the host machine's resources that are not utilized due to inefficient packing of the host machine, whereby more efficient packing results in less waste. In this manner, “expected waste” may refer to a statistical prediction of a likelihood that a host machine's resources will be stranded. The expected waste values 232 stored in the data 230 may not be specific to a particular host machine, but may instead be generalized for all host machines included in the computing environment. The expected waste values 232 stored in the data 230 may be specific to the particular distribution of VM types in the computing environment, such that these values could be used to determine expected waste for any computing environment having the same particular distribution of VM types. Stated another way, knowing the different types of VMs that can be deployed at a given computing environment, as well as the likelihood of each VM type being deployed, can be used to hone the statistical forecast of whether resources at any of the host machines included in the computing environment are likely to be stranded.

For further example, the data 230 may also include an indication of available resources at each of the host machines 234 included in the computing environment. Each host machine may be a candidate to serve as a host machine for a VM assigned to a workload. Hence, knowing the currently available resources at the host machine can serve to determine expected waste at the host machine at a current time, projected resource availability at the host machine if the host machine were selected to host the VM, and expected waste at the machine for the projected resource availability. These values may be utilized to inform more efficient assignment of VMs to certain host machines within the computing environment, as described in greater detail herein.

The instructions 240 stored in memory 220 may include one or more routines for processing and managing the incoming workload requests. These routines may include, but are not limited to, an expected waste calculation routine 242 for determining expected waste of current and projected or resultant scenarios at the various host machines of the computing environment, and a workload scheduling routine 244 for determining which VMs and which host machines should be assigned to each given workload received by the manager 200.

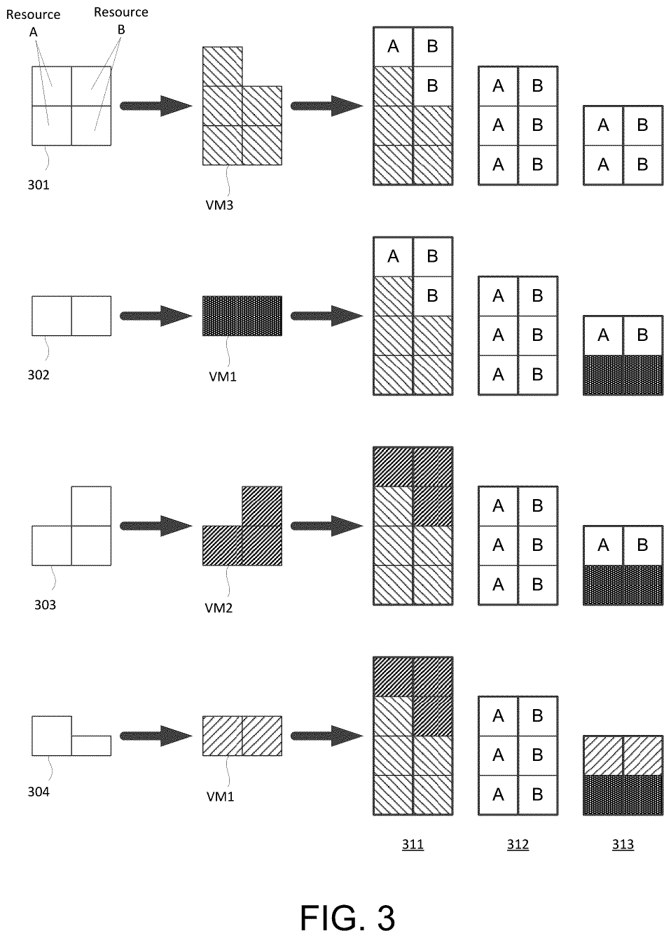

FIG. 3 illustrates an example distribution of workloads according to a workload scheduling routine, such as the workload scheduling routine 244 of FIG. 2. As shown in FIG. 3, each workload 301-304 may include multiple resources, whereby a quantity of a first resource (Resource A) is illustrated as a left-hand column, and a quantity of a second resource (Resource B) is illustrated as a right-hand column. For example, workload 301 requires 2 units of Resource A and 2 units of Resource B, whereas workload 303 requires 1 unit of Resource A and 2 units of Resource B. For example, Resource A may be a quantity of CPUs for executing the workload, and Resource B may be a quantity of GB of RAM required for executing the workload.

As further shown in FIG. 3, different VM types may be selected for each workload. Each selected VM type may carry sufficient resources in order to perform the workload. For instance, type VM1 includes 1 CPU and 1 GB of free RAM and is sufficient for workloads 302 and 304. Similarly, VM2 includes 1 CPU and 2 GB of free RAM and is sufficient for workload 303, and VM3 includes 3 CPU and 2 GB of free RAM and is sufficient for workload 301.

As further shown in FIG. 3, the workload manager may choose to bind the selected VM to any one of three candidate host machines 311, 312, 313 included in the computing environment. Each candidate host machine 311, 312, 313 may have a different amount of available resources, meaning that the expected waste of binding a given VM may be different for each of the host machines. In the example of FIG. 3, the workload manager selects the first machine 311 for the VM of the first workload 301, the third machine 313 for the VM of the second workload 302, the first machine 311 for the VM of the third workload 303, the third machine 313 for the VM of the fourth workload 304. Further explanation as to how each host machine is chosen for each workload is provided in connection with the example methods herein.

As shown in FIG. 3, the workload assignment routine 242 has the advantageous effect of fully packing each of the first and third machines 311, 313 while leaving the second machine 312 open for any future workloads. This is also advantageous compared to load-balancing strategies since load-balancing could leave insufficient room at any of the host machines to handle large workloads that arrive at a later time, whereas the bin packing methods using expected waste ensure both efficient packing of current workloads and projected efficient packing of future workloads.

### Example Methods

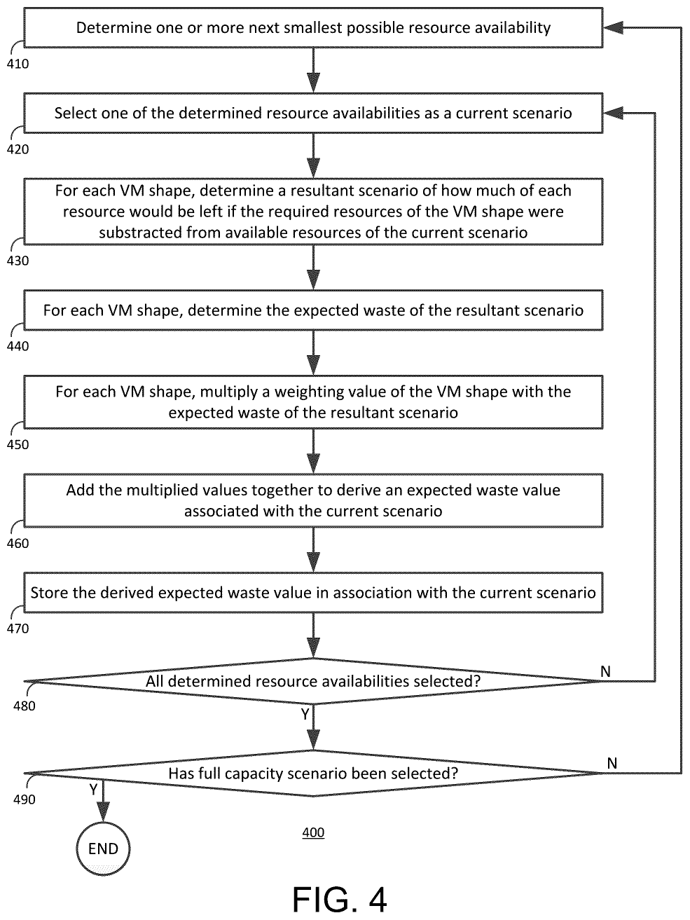

FIG. 4 is a flow diagram illustrating an example routine 400 for calculating expected waste. A precursor for the routine may be the calculation of a host machine having no resources available as having an expected waste of 0, since there are no resources left to be wasted.

Operations may begin at block 410 in which one or more scenarios having the next smallest possible resource availability are determined. For an expected waste calculation for two resources, such as available CPU and available memory, these scenarios may include a host machine hosting the smallest quantity of CPUs that could be left over after allocating the remaining CPUs to other workloads, such as 1 CPU, or the smallest quantity of RAM that could be free after allocating the remaining RAM to other workloads, such as 1 GB of free RAM in a case when all workloads require RAM in increments of 1 GB. In other examples, CPUs and RAM can be divided into different increments. For instance, if all workloads require an even number of GBs of RAM and all host machines have an even number of GBs of RAM available, then RAM could hypothetically be measured in 2 GB increments instead of 1 GB increments.

At block 420, one of the scenarios having the next smallest possible resource availability is selected. At block 430, for each shape VM in the known distribution of VMs, it is determined how much of each resource would be left if such a shape VM were added to a host machine having the available resources of the selected scenario, meaning that the VM resources of the VM shape were subjected from the available resources. The remaining resources will match with a scenario for which expected waste was previously calculated, referred to herein as the resultant scenario. At block 440, the expected waste for the resultant scenario is obtained. This may involve looking up the value in the lookup table. At block 450, for each shape VM in the known distribution of VMs, a weighting value of the shape VM is multiplied by the expected waste of the resultant scenario. The weighting value may be a percentage of the shape VM within the known distribution of VMs, such as 0.5 if 50% of the VMs are known to be a particular shape. At block 460, the products calculated at block 450 are summed together, thereby providing a weighted average of the expected wastes of each of the resultant scenarios. This sum corresponds to the expected waste of the selected scenario. At block 470, the expected waste of the selected scenario is stored. For instance, the expected waste may be stored in a lookup table for later use.

The distribution of VM types may be predetermined based on past workload history. Additionally or alternatively, distribution of VM types may be regularly refreshed, such as on a scale of hours, such as one hour or two hours. Once the distribution is updated, expected waste values may be recalculated. Workload assignment may be paused during this time, as the calculation process does not take a significant amount of time, such as being on the order of seconds.

At block 480, it is determined whether all of the scenarios having the next smallest possible resource availability have been selected. If there are other scenarios that have not yet been selected, then operations may revert to block 420, whereby another one of the scenarios may be selected and its expected waste calculated. Conversely, if all of the scenarios have already been selected, then operations may revert to block 490, where it is determined whether the selected scenario corresponds to the full available capacity of the host machine. If the selected scenario corresponds to the full available capacity of the host machine, then it may be determined to end operations, as expected waste for all scenarios of available resources have already been calculated. Conversely, if the selected scenario does not correspond to the full available capacity of the host machine, then operations may revert to block 410 in which one or more scenarios having the next smallest possible resource availability are determined. Operations may iteratively continue until expected waste has been calculated for all scenarios of available resources.

Although FIG. 4 shows a strictly sequential iterative process, it should be understood that at least some steps could be performed in parallel, such as performing the operations of blocks 420-460 in parallel with one another for each of the one or more scenarios determined at block 410.

It should be recognized that the routine 400 takes advantage of a recursive process, whereby expected waste for smaller groups of resources is first calculated, the results of those calculations are stored in the lookup table, and then those calculations are called in order to determine expected waste for relatively larger groups of resources.

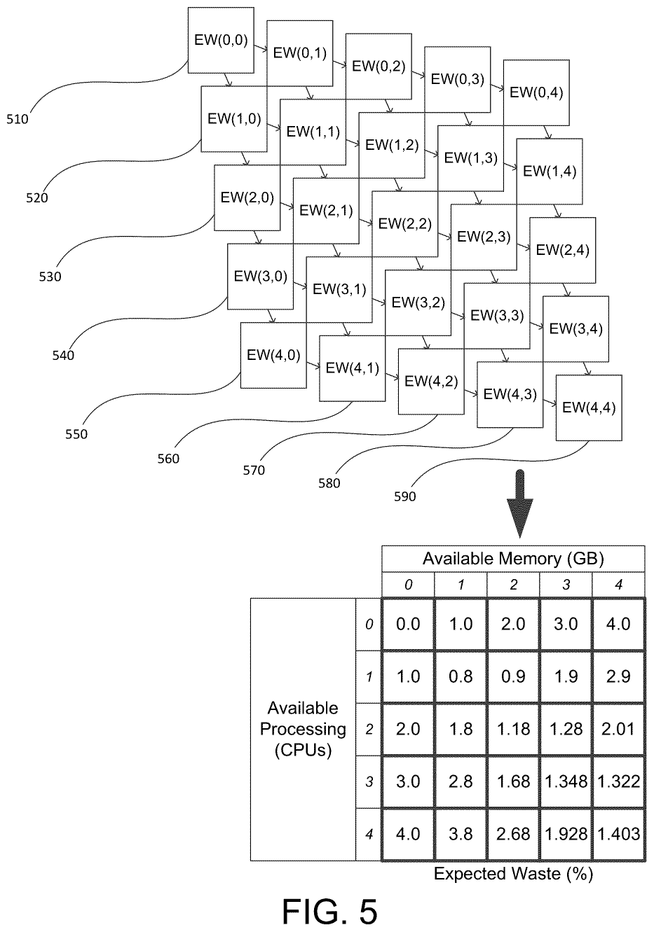

FIG. 5 is a chart illustrating the calculations of expected waste for a particular example distribution of VMs. The example of FIG. 5, is limited to two dimensions of resources, particularly, CPUs, which is tracked in increments of 1 CPU, and free RAM, which is tracked in increments of 1 GB. However, the same principles may be applied to determine expected waste for systems providing a larger number of different types of resources, such as three resources, four resources or more resources, and apportioning those resources according to any possible incrementations. Also, in the example of FIG. 5, and for the sake of simplicity, the expected waste is calculated only for host machines having up to 4 available CPUs and 4 GB of free RAM, although the same principles may be applied to calculate expected waste for host machines having any amount of CPUs or any amount of RAM.

In the example of FIG. 5, each expected waste scenario is denoted as EW(x,y), in which “x” is the number of available CPUs of the host machine and “y” is the number of GB of free RAM at the host machine for which the expected waste is being calculated. Also, in the example of FIG. 5, the distribution of VMs in the computing environment of the host machine is known to be 60% VMs requiring 1 CPU and 1 GB RAM (referred to herein as VM1), 30% VMs requiring 1 CPU and 2 GB RAM (referred to herein as VM2), and 10% VMs requiring 3 CPUs and 2 GB RAM (referred to herein as VM3).

At block 510, corresponding to the precursor for routine 400, expected waste for 0 CPU and 0 GB of free RAM is assumed to be 0. Next, at block 520, and corresponding to block 410 of FIG. 4, a next smallest amount of available resources is identified, which in this case is 1 CPU and 0 GB of RAM or 0 CPUs and 1 GB of RAM. Each of these scenarios is selected in turn. Alternatively, since the calculation of expected waste in each of these scenarios is independent of one another, the calculations could be performed in parallel.

For a host machine having 1 CPU and 0 GB RAM, the expected waste of this scenario, EW(1,0), is 1 corresponding to the 1 stranded CPU, since all known VM shapes require at least 1 GB RAM. Likewise, for a host machine having 0 CPUs and 1 GB RAM, the expected waste of this scenario, EW(0,1), is also 1 corresponding to the 1 stranded GB of RAM, since all known VM shapes require at least 1 CPU.

Next, at block 530, and corresponding to reverting to block 410, a next smallest possible resource availability scenario is determined. In this case, the next smallest possible resource availability scenario may be any one of 2 CPUs and 0 GB of free RAM, 1 CPU and 1 GB of free RAM, or 0 CPUs and 2 GB of free RAM

For a host machine having 2 CPUs and 0 GB RAM, the expected waste of this scenario, EW(1,0), is 2 corresponding to the 2 stranded CPUs, since all known VM shapes require at least 1 GB RAM. Likewise, for a host machine having 0 CPUs and 2 GB RAM, the expected waste of this scenario, EW(0,1), is also 2 corresponding to the 2 stranded GB of RAM, since all known VM shapes require at least 1 CPU.

Next, for a host machine having 1 CPU and 1 GB RAM, the expected waste is less than 2. Corresponding to block 430 of routine 400, each of VM1, VM2 and VM3 are evaluated to determine remaining resources at the host machine after adding each shape VM. Only VM1 fits into the 1 CPU/1 GB RAM space, and leaves no leftover or stranded space, thus making the expected waste of 0. VM2 and VM3 do not fit into the remaining space, and thus the 1 CPU and the 1 GB of RAM are already stranded in those scenarios, making the expected waste 2. Corresponding to block 450 of routine 400, the expected waste values may be multiplied by the percentage of each corresponding VM shape, meaning that for VM10.0 is multiplied by 60%, for VM2 2 is multiplied by 30%, and for VM3 2 is multiplied by 10%. Corresponding to block 450 of routine 400, the products of 0*60% (or 0.0*0.6), 2*30% (or 2*0.3), and 2*10% (or 2*0.1) are summed to arrive at a total expected waste of 0.8 for the scenario of EW(1,1). Hence, EW(1,1)=(0.6*0)+(0.3*2)+(0.1*2)=0.8.

At block 540, operations may continue by reverting to block 410 of routine 400 and determining the next smallest possible resource availability. As can be seen from the graphical illustration of FIG. 5, for a two-dimensional table of available resources, each next smallest possible resource availability may include any box for which the previous boxes along both dimensions of the table have already been calculated. Thus, the next smallest possible resource availability may include at block 540 may include each of 3 CPUs and 0 GB of free RAM, 2 CPUs and 1 GB of free RAM, 1 CPU and 2 GB of free RAM, and 0 CPUs and 3 GB of free RAM. For the sake of brevity, the scenarios corresponding to the remaining blocks 550, 560, 570 and 580 are not described in detail in the written description as they follow the same pattern outlined herein, and in any case, can be seen from the table of FIG. 5. Also, for the sake of brevity, it should be readily understood from the above examples that any of the remaining scenarios having 0 CPUs or 0 GB of free RAM available must have an expected waste corresponding to however many CPUs or however many GB of free RAM are remaining. Therefore, those scenarios are not described in detail herein.

For a host machine having 2 CPUs and 1 GB of free RAM, only VM1 fits into this available space, while VM2 and VM3 do not fit at all. Furthermore, even after VM1 is fit into the available space, there still remains 1 CPU and 0 GB of RAM, which has an expected waste of 1. Therefore, no matter which VM is attempted to be added to the host machine, there will inevitably be no space for the VM or wasted space as a result of binding the VM. Hence, EW(2,1) equals: (0.6*1)+(0.3*3)+(0.1*3)=1.8.

For a host machine having 1 CPU and 2 GB of free RAM, VM1 fits into the available space, but leaves 0 CPU and 1 GB, which has an EW(0,1)=1. V2 also fits into the available space, and leaves 0 CPU and 0 GB, which has an EW(0,0)=0. V3 does not fit, so the 1 CPU and 2 GB of RAM are already wasted. Hence, EW(1,2) is calculated to equal (0.6*1)+(0.3*0)+(0.1*3)=0.9. In effect, the workload scheduler is informed to favor avoiding a scenario in which 1 CPU and 2 GB of RAM remain than a scenario in which 2 CPU and 1 GB of RAM remain, since the expected waste for 1 CPU and 2 GB of RAM is twice as high.

To calculate EW(3,1), it is determined that VM1 fits into the available space, and leaves 2 CPU and 0 GB, which has an EW(2,0) of 2, and that V2 and V3 do not fit, so the space is already wasted. Hence, EW(3,1) is calculated to equal (0.6*2)+(0.3*4)+(0.1*4)=2.8.

For EW(2,2), VM1 fits into the available space, and leaves 1 CPU and 1 GB, which has an EW(1,1)=0.8. V2 fits into the available space, and leaves 1 CPU and 0 GB, which has an EW(1,0)=1. V3 does not fit, so the space is already wasted. Hence, EW(2,2) is calculated to equal (0.6*0.8)+(0.3*1)+(0.1*4)=0.48+0.3+0.4=1.18.

Remaining EW calculations for the table in FIG. 5 are shown below according to the same recursive processes described above.

EW(1,3)=(0.6*(EW(0,2))+(0.3*EW(0,1))+(0.1*4)=0.6*2+0.3*1+0.4=1.9.

EW(4,1)=(0.6*(EW(3,0))+(0.3*5)+(0.1*5)=0.6*3+1.5+0.5=3.8.

EW(3,2)=(0.6*(EW(2,1))+(0.3*(EW(2,0))+(0.1*0)=0.6*1.8+0.3*2=1.68.

EW(2,3)=(0.6*(EW(1,2))+(0.3*EW(1,1))+(0.1*5)=0.6*0.9+0.3*0.8+0.5=1.28.

EW(1,4)=(0.6*(EW(0,3))+(0.3*EW(0,2))+(0.1*5)=0.6*3+0.3*2+1.8=2.9.

EW(4,2)=(0.6*(EW(3,1))+(0.3*EW(3,0))+(0.1*EW(1,0))=0.6*2.8+0.3*3+0.1*1=2.68.

EW(3,3)=(0.6*(EW(2,2))+(0.3*EW(2,1))+(0.1*EW(0,1))=0.6*1.18+0.3*1.8+0.1*1=1.348.

EW(2,4)=(0.6*(EW(1,3))+(0.3*EW(1,2))+(0.1*6)=0.6*1.9+0.3*0.9+0.6=2.01.

EW(4,3)=(0.6*(EW(3,2))+(0.3*EW(3,1))+(0.1*EW(1,1))=0.6*1.68+0.3*2.8+0.1*0.8=1.928.

EW(3,4)=(0.6*(EW(2,3))+(0.3*EW(2,2))+(0.1*EW(0,2))=0.6*1.28+0.3*1.18+0.1*2=1.322.

EW(4,4)=(0.6*(EW(3,3))+(0.3*EW(3,2))+(0.1*EW(1,2))=0.6*1.348+0.3*1.68+0.1*0.9=1.403.

From the EW calculations shown in FIG. 5, it can be seen that certain scenarios of resource availability lead to better bin packing solutions than other scenarios. For example, the expected waste is at a minimum of 0.8 when there is 1 CPU and 1 GB of free RAM remaining at a host machine. For further example, the expected waste is lower for a host machine having 3 CPUs and 4 GB of free RAM remaining than for a host machine having 4 CPUs and 3 GB of RAM remaining. These calculations can be used to inform decisions made by a workload scheduler.

Although the chart of FIG. 5 is limited to two dimensions, it should be appreciated that the same principles can be extended to three or more dimensions of resources. For instance, for three dimensions, a first step involves setting EW(0,0,0)=1, then determining EW(1,0,0), EW(0,1,0) and EW(0,0,1), and proceeding from there until an entire three-dimensional table is completed. It should be recognized that processing limitations may limit the number of dimensions that can be calculated, the range of variables in each added dimension, or both. However, since calculations can be performed in advance, adding dimensions to expected waste determinations is still more efficient than adding dimensions to other packing algorithms. Additionally, the chart of FIG. 5 depicts a setup in which stranded CPUs and stranded GB of RAM are equally weighted. However, in other example setups, one dimension may be more heavily weighted. This may be done in order to prioritize the avoidance of stranding in a particular dimension. For instance, if it is more important to avoid stranding of RAM than of CPUs, the EW calculations may be set up to count each stranded GB of RAM with a value of 2 but each stranded CPU with a value of 1, so as attribute higher costs to scenarios resulting in more stranded RAM.

Also, although the expected waste values illustrated in FIG. 5 are shown in the form of a chart, it should be understood that other data structures may be used to store the values. Additionally or alternatively, although the chart of expected waste values shown in FIG. 5 is exhaustive, it should be understood that in other examples, the list of expected waste values may be non-exhaustive, and changes in expected waste can be approximated based on the stored values.

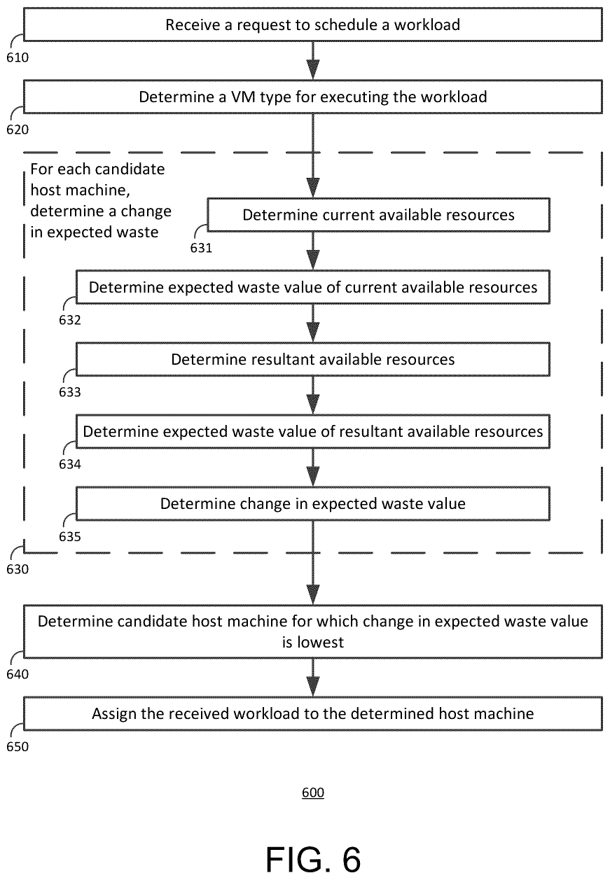

FIG. 6 is a flow diagram illustrating an example of workload scheduling routine 600 executed by a workload scheduler. At block 610, the workload scheduler receives a request to schedule a workload. The request may specify an amount of resources required for executing the workload. Resources may include an amount of processing, such as a total number of CPUs, needed to execute the workload. Additionally or alternatively, resources may include an amount of memory, such as a total number of GB of free RAM, needed to execute the workload. Other types of resources may be specified in the request in addition to or in place of the aforementioned example resources.

At block 620, the workload scheduler determines a VM type for executing the workload. In some cases, the amount of resources needed by the workload may not match perfectly with an available VM shape, in such an instance, the workload scheduler may select a VM shape that best fits the required resources without having fewer than the required resources. For example, a workload requiring 2 CPUs and 2 GB of free RAM may be assigned to a VM3-type VM, since the VM1 and VM2 types of VMs do not provide enough CPUs for executing the workload. For further example, a workload requiring 1 CPU and 0.5 GB of free RAM may be assigned to a VM1-type VM, since despite being executable by all of the VM types, the VM1 type has the fewest excess resources.

At block 630, the workload scheduler determines, for each of the candidate host machines within the computing environment, a change in expected waste of the host machine's resources that would result from binding a VM assigned to the workload to the host machine. The change in expected waste may effectively be a score indicating a likelihood of resources at the host machine remaining unused if the VM assigned to the workload is assigned to the host machine.

In some examples, the change in expected waste may be determined by a sub-routine shown in FIG. 6 as sub-blocks 641-645.

At sub-block 631, the workload scheduler determines an available amount of resources for the workload at the host machine. The determination may involve querying the host machines themselves to determine available resources, or querying one or more information sources tracking resource availability for each of the host machines.

At sub-block 632, the workload scheduler determines the expected waste value associated with the currently available resources. For each host machine, the expected waste is a single value that may be pre-calculated and stored in a table accessible to the workload manager. As described in connection with FIGS. 4 and 5, the expected waste value may be a function of the known VM types in the computing environments, the distribution of the known VM types, and a set of available resources. The table may include a different expected waste value for each different set of available resources, whereby the expected waste value for each host machine may be looked up by finding the value associated with the set of available resources that corresponds to the host machine's currently available resources.

At sub-block 633, the workload scheduler determines the resultant available resources at the host machine if the host machine were selected for the workload. This determination may involve subtracting the resources of the determined VM type at block 620 from the currently available resources of the host machine determined at sub-block 631.

At sub-block 634, the workload scheduler determines the expected waste value associated with the resultant available resources. This expected waste may be looked up for each host machine by finding the value associated with the set of available resources that corresponds to the resultant available resources of the host machine. Since the resultant available resources of each host machine may be different, the expected waste value associated with the resultant available resources for each host machine may also be different.

At sub-block 635, the workload scheduler determines for each host machine a difference between the expected waste value associated with the currently available resources and the expected waste value associated with the resultant available resources.

At block 640, the workload scheduler determines the candidate host machine for which the change in expected waste is lowest, meaning that the expected waste from the current value to the resultant value has decreased by the most or increased by the least. Since each candidate host machine may have a different amount of available resources, the change in expected waste for each host machine may be different. By selecting the host machine with the lowest change in expected waste, the workload scheduler avoids packing the host machines in a manner that promotes or increases the likelihood of stranding.

At block 650, the workload scheduler assigns the determined host machine to the received workload. This may result in binding a VM of the VM type selected at block 620 to the determined host machine, and then assigning the VM to the received workload for execution. In this manner, the resources of the plurality of candidate host machines may be efficiently packed for the entire computing environment so as to minimize stranding and to increase the likelihood of spaces for large workloads being maintained within the environment.

Notably, because the expected waste values are pre-calculated and pre-stored, the time required for determining expected waste for each candidate host machine is minimized and increases linearly with the number of candidate host machines. This is because no complex computations are performed at the time of the lookup. In this regard, for any given host machine, determining the change in expected waste requires no more than two lookup operations: a lookup for the expected waste associated with the current scenario; and a lookup for the expected waste associated with the resultant scenario. Furthermore, these two lookup operations may be skipped for some host machines, such as if the host machine does not have sufficient resources to host the determined VM type, thereby reducing processing time even further.

Returning to the example diagram of FIG. 3, it should be noted that this diagram illustrates operations carried out by the example routine 600 FIG. 6. In FIG. 3, each of the three candidate host machines 301, 302, and 303 have different amounts of available resources: the first machine 301 has 4 CPUs and 4 GB of free RAM; the second machine 302 has 3 CPUs and 3 GB of free RAM; and the third machine 303 has 2 CPUs and 2 GB of free RAM. Therefore, the workload scheduler can differentiate the appropriateness of each candidate host machine for assigning workloads based on their different available resources and the expected waste resulting from subtracting the required resources of the workload from the available resources.

In the case of the first workload 311, which requires 2 CPUs and 2 GB of free RAM, it may be determined to use a VM of VM3-type since the other VM types cannot support the resource requirements of the workload. It may be determined that binding VM3 to the first candidate host machine 301 results in reducing the first machine 301 from 4 CPU to 1 CPU and from 4 GB to 2 GB, thus changing the expected waste from 1.403 to 0.9, resulting in a change in expected waste of −0.503. It may also be determined that binding VM3 to the second machine 302 results in reducing the second machine 302 from 3 CPU to 0 CPU and from 3 GB to 1 GB, thus changing the expected waste from 1.348 to 1, and resulting in a change in expected waste of −0.348. It may also be determined that binding VM3 to the third machine 303 is not possible because the third machine 303 does not have sufficient resources available. Thus, the workload manager may select the first machine 301 for the first workload 311 since the change in expected waste is lower than it is for the second machine 302.

Then, in the case of the second workload 312, which requires 1 CPU and 1 GB of free RAM, it may be determined to use a VM of VM1-type so as to avoid wasting excess resources. It may be determined that binding VM1 to the first candidate host machine 301 results in reducing the first machine 301 from 1 CPU to 0 CPU and from 2 GB to 1 GB, thus changing the expected waste from 0.9 to 1, resulting in a change in expected waste of +0.1. It may also be determined that binding VM1 to the second machine 302 results in reducing the second machine 302 from 3 CPU to 2 CPU and from 3 GB to 2 GB, thus changing the expected waste from 1.348 to 1.18, and resulting in a change in expected waste of −0.168. It may also be determined that binding VM1 to the third machine 303 results in reducing the third machine 303 from 2 CPU to 1 CPU and from 2 GB to 1 GB, thus changing the expected waste from 1.18 to 0.8, and resulting in a change in expected waste of −0.28. Thus, the workload manager may select the third machine 303 for the second workload 312 since the change in expected waste is lowest.

Then, in the case of the third workload 313, which requires 1 CPU and 2 GB of free RAM, it may be determined to use a VM of VM2-type so as to avoid wasting excess resources. It may be determined that binding VM2 to the first candidate host machine 301 results in reducing the first machine 301 from 1 CPU to 0 CPU and from 2 GB to 0 GB, thus changing the expected waste from 0.9 to 0, resulting in a change in expected waste of −0.9. It may also be determined that binding VM2 to the second machine 302 results in reducing the second machine 302 from 3 CPU to 2 CPU and from 3 GB to 1 GB, thus changing the expected waste from 1.348 to 1.8, and resulting in a change in expected waste of +0.452. It may also be determined that binding VM3 to the third machine 303 is not possible because the third machine 303 does not have sufficient resources available. Thus, the workload manager may select the first machine 303 for the third workload 313 since the change in expected waste is lower than it is for the second machine 302.

Then in the case of the fourth workload 314, which requires 1 CPU and 0.5 GB of free RAM, it may be determined to use a VM of VM1-type since the resource requirements most closely fit the resources of the VM1-type of VM. There is no remaining capacity at the first machine 301. It may be determined that binding VM1 to the second machine 302 results in reducing the second machine 302 from 3 CPU to 2 CPU and from 3 GB to 2 GB, thus changing the expected waste from 1.348 to 1.18, and resulting in a change in expected waste of +0.452. It may also be determined that binding VM1 to the third machine 303 results in reducing the second machine 302 from 1 CPU to 0 CPU and from 1 GB to 0 GB, thus changing the expected waste from 0.8 to 0, and resulting in a change in expected waste of −0.8. Thus, the workload manager may select the third machine 303 for the fourth workload 314 since the change in expected waste is lower than for the second machine 302.

The above example demonstrates how the workload manager can strategically distribute workloads among the various host machines of a computing environment while also maintaining or even improving expected waste values as the packing procedure progresses. In the example of FIG. 3, it can be seen that two of the three host machines were packed with no stranding, while the remaining host machine remained untouched, thus leaving it available for any relatively large workloads that are later received.

Simulations of the waste minimization techniques of the present disclosure were run against our previous bin packing algorithms. According to the simulations, CPU stranding was reduced from 11.6% using the prior algorithms to 10.7% using the waste minimization algorithm. Also according to the simulations, memory stranding was reduced from 19.2% using the prior algorithms to 18.2% using the waste minimization algorithm. As the size of the cloud network increases, the absolute magnitude of these savings will continue to increase over time as well.

The above examples generally describe using change in expected waste according to weighted calculations of expected waste to determine efficient packing. However, it should be appreciated that other calculations can be used to achieve the same or similar effects. For example, instead of change in expected waste between current and resultant scenarios being used, expected waste could be determined based only on the value associated with the resultant scenario, for instance by selecting the VM for which the resulting expected waste is lowest. For further example, instead of weighting the different VM types, in a system where VM distribution is unknown or hard to predict, the VM types can be unweighted.

Additionally, while the above examples generally describe workload assignment according to the expected waste algorithms, it should be understood that additional assignment techniques may benefit from the same or similar principles where those assignments are for projects or jobs that take up computing resources in an environment having multiple candidate computing devices.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order, such as reversed, or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method of assigning a workload to host machines of a computing environment, the method comprising:
receiving, by one or more processors, a request to schedule a workload;
selecting, by the one or more processors, a virtual machine type for executing the workload;
for each candidate host machine of a plurality of candidate host machines, determining, by the one or more processors, an expected waste score indicating a likelihood of resources at the respective candidate host machine remaining unused if the virtual machine type is assigned to the respective candidate host machine, wherein the expected waste score is based on a predetermined set of available virtual machine types for the computing environment, wherein the selected virtual machine type for executing the workload is included in the set of available virtual machine types for the computing environment; and
assigning, by the one or more processors, the workload to the respective candidate host machine having the lowest expected waste score.

2. The method of claim 1, wherein the request to schedule the workload indicates an amount of resources consumed by the workload, and wherein selecting the virtual machine type for executing the workload is based on the amount of resources consumed by the workload.

3. The method of claim 2, wherein determining the expected waste score comprises accessing, by the one or more processors, predetermined expected waste values, each predetermined expected waste value corresponding to a different set of available resources.

4. The method of claim 3, wherein determining the expected waste score further comprises:
determining, by the one or more processors, a current set of available resources at the candidate host machine;
determining, by the one or more processors, a first expected waste value corresponding to the current set of available resources from the predetermined expected waste values;
determining, by the one or more processors, a resultant set of available resources at the candidate host machine if the virtual machine type is assigned to the candidate host machine;
determining, by the one or more processors, a second expected waste value corresponding to the resultant set of available resources from the predetermined expected waste values; and
determining, by the one or more processors, a difference between the first expected waste value and the second expected waste value.

5. The method of claim 1, wherein the resources at the candidate host machine include each of processing resources and storage resources, and wherein the predetermined expected waste values are based on both processing resources and storage resources.

6. The method of claim 5, wherein the processing resources include a number of central processing units (CPUs), and wherein the storage resources include at least one of an amount of random access memory or an amount of solid-state drive memory.

7. The method of claim 1, wherein assigning the workload to the selected candidate host machine comprises:
binding, by the one or more processors, a virtual machine of the determined virtual machine type to the selected candidate host machine; and
assigning the virtual machine to execute the workload.

8. The method of claim 1, further comprising calculating the expected waste values before the request to schedule the workload is received.

9. The method of claim 8, wherein calculating the expected waste values comprises:
selecting, by the one or more processors, a first set of resources;
for each virtual machine type of a plurality of virtual machine types, determining, by the one or more processors, a first likelihood of resources being unused if a hypothetical virtual machine of the virtual machine type were added to a hypothetical host machine of the computing environment having the first set of resources;
deriving, by the one or more processors. a first expected waste value from the determined first likelihoods of the plurality of virtual machine types;
selecting, by the one or more processors, a second set of resources, wherein the first set of resources is a subset of the second set of resources;
for each virtual machine type of a plurality of virtual machine types, determining, by the one or more processors. a second likelihood of resources being unused if a hypothetical virtual machine of the virtual machine type were added to a hypothetical host machine of the computing environment having the second set of resources, wherein at least one second likelihood is determined based at least in part on the first expected waste value; and
deriving, by the one or more processors, a second expected waste value from the determined second likelihoods of the plurality of virtual machine types.

10. The method of claim 9, wherein each of the first likelihoods and each of the second likelihoods is weighted according to a predetermined distribution of the plurality of virtual machine types in the computing environment.

11. A system for assigning a workload to a host machine of a computing environment, the system comprising:
one or more processors; and
memory storing instructions configured to cause the one or more processors to:
receive a request to schedule a workload;
select a virtual machine type for executing the workload;
for each candidate host machine of a plurality of candidate host machines, determine an expected waste score indicating a likelihood of resources at the candidate host machine remaining unused if the virtual machine type is assigned to the candidate host machine, wherein the expected waste score is based on a predetermined set of available virtual machine types for the computing environment, wherein the selected virtual machine type for executing the workload is included in the set of available virtual machine types for the computing environment;
select the candidate host machine for which the expected waste score is lowest; and
assign the workload to the selected candidate host machine.

12. The method of claim 11, wherein the request to schedule the workload indicates an amount of resources consumed by the workload, and wherein the instructions are configured to cause the one or more processors to select the virtual machine type for executing the workload based on the amount of resources consumed by the workload.

13. The method of claim 12, wherein the instructions are configured to cause the one or more processors to access predetermined expected waste values, each predetermined expected waste value corresponding to a different set of available resources.

14. The method of claim 13, wherein the instructions are configured to cause the one or more processors to:
determine a current set of available resources at the candidate host machine;
determine a first expected waste value corresponding to the current set of available resources from the predetermined expected waste values;
determine a resultant set of available resources at the candidate host machine if the virtual machine type is assigned to the candidate host machine;
determine a second expected waste value corresponding to the resultant set of available resources from the predetermined expected waste values; and
determine a difference between the first expected waste value and the second expected waste value, wherein the expected waste score indicates the difference between the first expected waste value and the second expected waste value.

15. The method of claim 11, wherein the resources at the candidate host machine include each of processing resources and storage resources, and wherein the predetermined expected waste values are based on both processing resources and storage resources.

16. The method of claim 15, wherein the processing resources include a number of central processing units (CPUs), and wherein the storage resources include at least one of an amount of random access memory or an amount of solid-state drive memory.

17. The method of claim 11, wherein the instructions are configured to cause the one or more processors to:
bind a virtual machine of the determined virtual machine type to the selected candidate host machine; and
assign the virtual machine to execute the workload.

18. The method of claim 11, wherein the instructions are configured to cause the one or more processors to calculate the predetermined expected waste values before the request to schedule the workload is received.

19. The method of claim 18, wherein the instructions are configured to cause the one or more processors to:
select a first set of resources;
for each virtual machine type of a plurality of virtual machine types, determine a first likelihood of resources being unused if a hypothetical virtual machine of the virtual machine type were added to a hypothetical host machine of the computing environment having the first set of resources;
derive a first expected waste value from the determined first likelihoods of the plurality of virtual machine types;
select a second set of resources, wherein the first set of resources is a subset of the second set of resources;
for each virtual machine type of a plurality of virtual machine types, determine a second likelihood of resources being unused if a hypothetical virtual machine of the virtual machine type were added to a hypothetical host machine of the computing environment having the second set of resources, wherein at least one second likelihood is determined based at least in part on the first expected waste value; and
derive a second expected waste value from the determined second likelihoods of the plurality of virtual machine types.

20. The method of claim 19, wherein each of the first likelihoods and each of the second likelihoods is weighted according to a predetermined distribution of the plurality of virtual machine types in the computing environment.
